(19) United States
(12) Patent Application Publication
(10) Pub. No.: US 2013/0199508 A1
(43) Pub. Date: Aug. 8, 2013

(54) METHOD FOR CONTROLLING THE IGNITION POINT IN AN INTERNAL COMBUSTION ENGINE BY MEANS OF A CORONA DISCHARGE

(71) Applicant: BORGWARNER BERU SYSTEMS GMBH, Ludwigsburg (DE)

(72) Inventors: Olaf Toedter, Walzbachtal (DE); Steffan Bohne, Freiburg (DE); Martin Trump, Stuttgart (DE)

(73) Assignee: BORGWARNER BERU SYSTEMS GMBH, Ludwigsburg (DE)

(21) Appl. No.: 13/748,668

(22) Filed: Jan. 24, 2013

(30) Foreign Application Priority Data
Feb. 1, 2012 (DE) 10 2012 100 841.8

(51) Int. Cl. F02P 23/00

(52) U.S. Cl. CPC F02P 23/00
USPC 123/594

(57) ABSTRACT

A method for controlling the ignition point of a fuel/air mixture in an internal combustion engine by at least one corona discharge starting from an electrode, wherein at least one of the corona discharges is ignited at a crankshaft angle between 400° and 200° before the top dead center, with which the power stroke starts, by applying an ignition voltage to the electrode(s), and the energy input of the corona discharge or of the corona discharges is controlled by adapting the burn time of the corona discharge and the strength of the ignition voltage. The fuel/air mixture ignites at a crankshaft angle between 30° and 5° before the top dead center, with which the power stroke starts, and 50% of the fuel of the fuel/air mixture is combusted at a crankshaft angle between 6° and 10° after the top dead center point, with which the power stroke starts.

### RELATED APPLICATIONS

This application claims priority to DE 10 2012 100 841.8, filed Feb. 1, 2012 which is hereby incorporated herein by reference in its entirety.

### BACKGROUND

This disclosure relates to a method for controlling the ignition point of a fuel/air mixture in a cyclically operating internal combustion engine by means of at least one corona discharge starting from an electrode.

U.S. Pat. No. 6,986,342 B2 describes an homogeneous charge compression ignition (HCCI) engine and cites corona discharges as an option for compensating for fluctuations in the ignition point.

How corona discharges can be produced to ignite a fuel/air mixture is described for example in European Patent No. 1 515 594 A2 or U.S. Publication No. 2004/0129241 A1. Corona discharges arise from an electrode, to which an ignition voltage is applied. The ignition voltage is a high-frequency alternating voltage, which typically has values between 30 kHz and 10 MHz and between 10 kV and 500 kV.

### SUMMARY

This disclosure presents a way in which the fuel combustion and, in association therewith, also engine performance of an internal combustion engine can be improved.

With a method according to this disclosure, the ignition point of a fuel/air mixture is controlled in a cyclically operating internal combustion engine by one or more corona discharges. Should a plurality of corona discharges be used in a work cycle consisting of four strokes, these can be started simultaneously or in succession. The corona discharges can also be extinguished at different moments.

Ions and radicals are generated by a corona discharge. The higher the concentration of ions and radicals in a fuel/air mixture, the easier said mixture ignites. If a critical concentration is reached, which is dependent on pressure and temperature, a fuel/air mixture ignites in the combustion chamber of an engine. The ignition point of a fuel/air mixture in a four-stroke engine can therefore be controlled by a corona discharge.

In a method according to this disclosure, the corona discharge or at least one of the corona discharges is started at a crankshaft angle between 400° and 200° before the top dead center, with which the power stroke starts, by applying an ignition voltage to the electrode or the electrodes. The “top dead center,” with which the power stroke starts, is often referred to in the literature as the ignition TDC. Since the corona discharge is started at a crankshaft angle between 400° and 200° before the top dead center, with which the power stroke starts, a high concentration of ions and radicals is advantageously reached in the combustion chamber, and the ions and radicals can distribute well in the combustion chamber before ignition of the fuel mixture.

The internal combustion engine with which the method according to this disclosure is operated is a four-stroke engine. A work cycle of the internal combustion engine thus consists of an intake stroke, a compression stroke, a power stroke and an exhaust stroke. The crankshaft angle changes during each of these four strokes by 180° in each case. Overall, the crankshaft angle thus changes by 720° during a full cycle of the engine.

The energy input of the corona discharge or the corona discharges is controlled by adapting the burn time of the corona discharge and the electrical power thereof, in particular the strength of the ignition voltage. The number of ions and radicals generated is dependent on the energy input. In accordance with this disclosure, the energy input is controlled such that the fuel mixture ignites at a crankshaft angle between 30° and 5° before the top dead center, with which the power stroke starts, and 50% of the fuel of the fuel/air mixture is combusted at a crankshaft angle between 6° and 10° after the top dead center, with which the power stroke starts. Particularly efficient fuel combustion is thus achieved.

So that 50% of the fuel of the fuel/air mixture is combusted at a crankshaft angle between 6° and 10°, preferably between 7° and 9°, after the top dead center, with which the power stroke starts, a much earlier ignition start of the fuel mixture is necessary in conventional ignition devices, which generate an arc discharge. Since the ignition and the fuel combustion can be prepared by a corona discharge, a much quicker fuel combustion process can be achieved however, such that a subsequent ignition at a crankshaft angle between 30° and 5° before the top dead center, with which the power stroke starts, is sufficient.

In individual cases it may be that another ignition point, that is to say start of combustion, is advantageous with particular operating states of an engine. Nonetheless, the energy input of the corona discharge or corona discharges is in one embodiment of this disclosure controlled such that the fuel mixture when the engine is running is always ignited at a crankshaft angle between 30° and 5° before the top dead center, with which the power stroke starts. In other words, the energy input of the corona discharge or corona discharges is then controlled such that the fuel mixture is ignited in each work cycle at a crankshaft angle between 30° and 5° before the top dead center, with which the power stroke starts. It is usually advantageous if the energy input of the corona discharge or corona discharges is controlled such that the fuel mixture is always ignited at a crankshaft angle between 25° and 5° before the top dead center, with which the power stroke starts. It is particularly advantageous if the energy input of the corona discharge or corona discharges is controlled such that the fuel mixture is always ignited at a crankshaft angle between 5° and 20° before the top dead center, with which the power stroke starts.

In an embodiment a homogeneous compression ignition is prepared by the at least one corona discharge or the plurality of corona discharges. When the fuel mixture then ignites, a homogeneous compression ignition thus takes place. In some engines, operating states may occur in which homogeneous compression ignition cannot be achieved in spite of use of one or more corona discharges. In this case, an extraneous ignition can be achieved by increasing the energy input of the corona discharge or corona discharges. Although this leads to a slightly poorer combustion compared to a homogeneous compression ignition, it still enables efficient engine operation.

According to an advantageous refinement of this disclosure, the corona discharge or at least one of the corona discharges is started in each work cycle before the injection of fuel. Ions and radicals, which can be generated by a corona discharge, can thus be distributed in the combustion chamber of the engine by the injection process. The corona discharge or at least one of the corona discharges with a running engine may be always started before the injection of fuel. In other words, the corona discharge or at least one of the corona discharges start in each work cycle of the internal combustion engine before the injection of fuel.

According to an advantageous refinement of this disclosure, the power released by the one corcona discharge or the plurality of corona discharges in a work cycle of the internal combustion engine has at least two maxima, for example at least three maxima. The maxima can be formed with a continuously burning corona discharge by temporarily reducing the electrical power, for example during the injection process. It is also possible to achieve maxima by individual corona discharges. For example, a corona discharge may be extinguished, e.g. before or during the injection process, and later started again.

A first maximum of the electrical power of the corona discharge or of the total electrical power of a plurality of corona discharges in one embodiment lies before the injection of fuel, and a second maximum may occur after the injection of fuel. The electrical power of the corona discharge or the corona discharges, that is to say the product of current and voltage, thus rises initially with the ignition of a corona discharge before the injection of fuel and then falls, so as to then rise again. The first maximum is then preferably greater than the second maximum, but this is not absolutely necessary. A third maximum, which may be greater than the second maximum, can follow the second maximum in a work cycle.

For example, a high concentration of ions and radicals in the combustion chamber can be achieved with a first corona discharge, which starts before the injection of fuel. An HCCI ignition can then be prepared with a second, smaller discharge. A third corona discharge may be started for the actual ignition of the fuel/air mixture. This third discharge may convert a greater power than the second discharge, and thus causes a greater energy input.

In a work cycle, a first corona discharge can be started before the injection of fuel and a second corona discharge can be started after the injection of fuel. In this case, it is preferable, though not necessary, if the first corona discharge is extinguished before the second corona discharge is started. For example, the first corona discharge can be extinguished before or during the injection. A third corona discharge may follow the second corona discharge before the fuel/air mixture is ignited.

According to a further advantageous refinement of this disclosure, the corona discharge or at least one of the corona discharges is always started at least at a crankshaft angle of 120°, e.g. at least at a crankshaft angle of 150°, before the injection of fuel while the engine is running. When fuel is injected, an advantageously large number of ions and radicals have thus already been generated.

According to a further advantageous refinement of this disclosure, the crankshaft angle always changes by at least 150°, e.g. by at least 180°, whilst the corona discharge or at least one of the corona discharges persists. Due to such a long-lasting corona discharge, a high production of ions and radicals is ensured, which provides optimal combustion conditions.

With a method according to this disclosure, the corona discharge or one of the corona discharges can be generated in a combustion chamber of the engine. It is also possible to generate the corona discharge or one of the corona discharges in an intake passage of the engine. It is particularly advantageous if a corona discharge is generated both in the intake passage and in the combustion chamber of the engine. An electrode from which the corona discharge in the intake passage originates and an electrode from which the corona discharge in the combustion chamber originates can be actuated sequentially. Ions and radicals can thus be formed by a corona discharge during intake in the intake passage and are then available in the combustion chamber. After the end of the intake stroke, the corona discharge can be interrupted in the intake passage, although it does not have to be interrupted, and the concentration of ions and radicals can be further increased by a corona discharge in the combustion chamber.

According to an advantageous refinement of this disclosure, a target value for the ignition point of the fuel/air mixture is predefined according to the operating state of the engine, in particular the rotational speed thereof, and the start and duration of the at least one corona discharge are then determined according to this target value. The target value for the ignition point and the start and duration of the at least one corona discharge can be determined for example by characteristic curves or characteristic maps. In this case, the energy input of the corona discharge or corona discharges may also be controlled by adapting the electrical power of the corona discharge, for example by controlling the ignition voltage. The ignition voltage can be set by means of a characteristic map according to the engine operating state.

The corona discharge or the corona discharges can be interrupted completely before the fuel/air mixture ignites. However, it is also possible for the corona discharge or for one of the corona discharges to also continue to burn after ignition of the fuel/air mixture. So as to minimise an unnecessary load on the on-board power supply system, all corona discharges may be extinguished before the fuel/air mixture ignites, e.g. at least before 50% of the fuel/air mixture has combusted.

### BRIEF DESCRIPTION OF THE DRAWINGS

Further details of embodiments of this disclosure are explained by means of the appended drawings, wherein:

FIG. 1 shows a schematic depiction of the design of a corona ignition system for a vehicle engine; and

FIG. 2 shows, schematically, a longitudinal cross section of a cylinder of an internal combustion engine, which is connected to the ignition system shown in FIG. 1.

### DETAILED DESCRIPTION

The embodiments described below are not intended to be exhaustive or to limit the invention to the precise forms disclosed in the following detailed description. Rather, the embodiments are chosen and described so that others skilled in the art may appreciate and understand the principles and practices of the present invention.

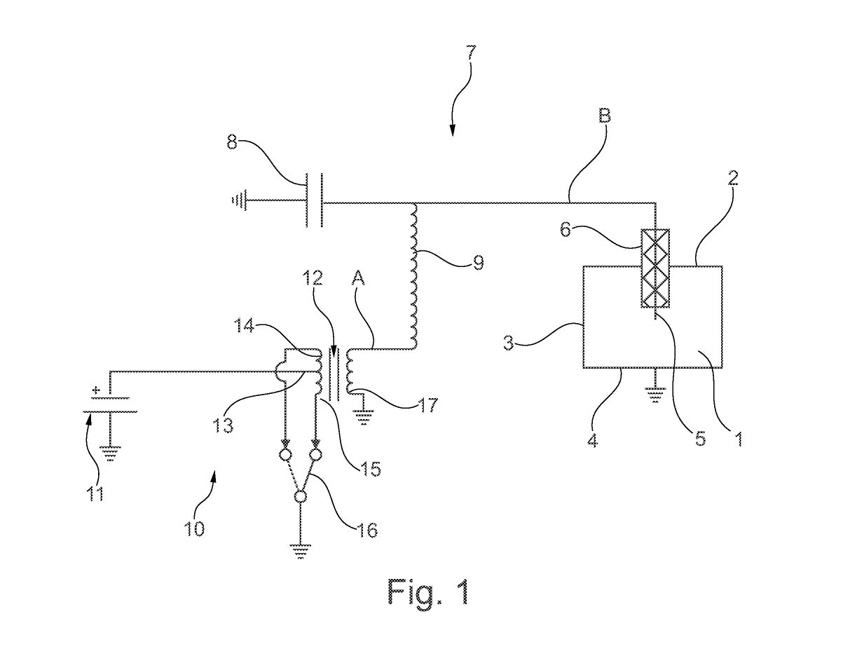

FIG. 1 shows a combustion chamber 1 which is delimited by walls 2, 3, and 4 that are at ground potential. An ignition electrode 5 which is enclosed by an insulator 6 along a portion of the length thereof extends into the combustion chamber 1 from above, and is guided through the upper wall 2 into the combustion chamber 1 in an electrically insulated manner by way of said insulator. The ignition electrode 5 and the walls 2 to 4 of the combustion chamber 1 are part of a series oscillating circuit 7 which also includes a capacitor 8 and an inductor 9. The series oscillating circuit 7 can also comprise further inductors and/or capacitors, and other components that are known to a person skilled in the art as possible components of series oscillating circuits.

A DC/AC converter is provided for excitation of the oscillating circuit 7, which in the example shown is formed by a high-frequency generator 10 comprising a DC voltage source 11 and a transformer 12 having a center tap 13 on the primary side thereof, thereby enabling two primary windings 14 and 15 to meet at the center tap 13. To produce a corona discharge, a primary voltage is applied to the DC/AC converter, namely at the center tap 13. The primary voltage can be generated from the voltage of the DC voltage source 11, e.g. using a method of pulse-width modulation, and can thereby be adjusted to a desired value.

Using a high-frequency switch 16, the ends of the primary windings 14 and 15 opposite the center tap 13 are connected to ground in alternation. The switching rate of the high-frequency switch 16 determines the frequency with which the series oscillating circuit 7 is excited, and can be changed. The secondary winding 17 of the transformer 12 supplies the series oscillating circuit 7 at the point A. The high-frequency switch 16 is controlled using a not-shown closed control loop such that the oscillating circuit is excited with the resonance frequency thereof. The voltage between the tip of the ignition electrode 5 and the walls 2 to 4 that are at ground potential is therefore at a maximum.

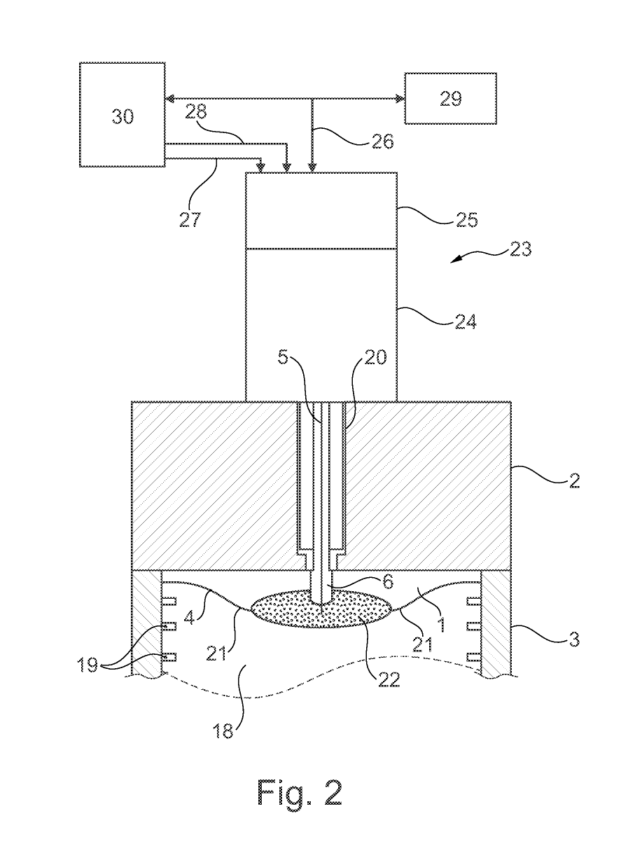

FIG. 2 shows a longitudinal cross section of a cylinder of an internal combustion engine equipped with the ignition device depicted schematically in FIG. 1. The combustion chamber 1 is limited by an upper wall 2 in the form of a cylinder head, a cylindrical circumferential wall 3, and the top side 4 of a piston 18 which is equipped with piston rings 19 and can move back and forth in the cylinder.

The cylinder head 2 comprises a passage 20 through which the ignition electrode 5 extends in an electrically insulated and sealed manner. The ignition electrode 5 is enclosed along at least a portion of the length thereof by an insulator 6 which may be a sintered ceramic, e.g. an aluminium oxide ceramic. The ignition electrode 5 extends via the tip thereof into the combustion chamber 1 and extends slightly past the insulator 6, although it could be flush therewith or even covered with a thin layer of insulating material.

A few sharp-edged projections 21 can be provided on the top side of the piston 18 in the environment of the tip of the ignition electrode 5, which are used to locally increase the electric field strength between the ignition electrode 5 and the piston 18 situated opposite thereto. When the oscillating circuit 7 is excited, a corona discharge forms primarily in the region between the ignition electrode 5 and optionally provided projections 21 of the piston 18, and can be accompanied by a more or less intensive charge carrier cloud 22.

A housing 23 is placed onto the outer side of the cylinder head 2. The primary windings 14 and 15 of the transformer 12, and the high-frequency switch 16 interacting therewith, are located in a first compartment 24 of the housing 23. A second compartment 25 of the housing 23 contains the secondary winding 17 of the transformer 12 and the remaining components of the series oscillating circuit 7, and, optionally, means for observing the behavior of the oscillating circuit 7. An interface 26 can be used to establish a connection, for example, to a diagnostic unit 29 and/or an engine control unit 30.

An example of a method for controlling the ignition point of a fuel/air mixture in a cyclically operating internal combustion engine by means of at least one corona discharge originating from an ignition electrode is explained in the following. The method comprises monitoring the crankshaft angle. If the crankshaft angle reaches a set value a corona discharge is started by applying an ignition voltage to the ignition electrode or the electrodes. The set value is between 400° and 200° before the top dead center, with which a power stroke of the engine starts. More particularly, the set value is before the injection of fuel.

The energy input of the corona discharge or of the corona discharges is then controlled by adapting the burn time of the corona discharge and the strength of the ignition voltage such that the fuel/air mixture ignites at a crankshaft angle between 30° and 5° before the top dead center, with which the power stroke starts. Moreover, the energy input of the corona discharge or of the corona discharges is controlled by adapting the burn time of the corona discharge and the strength of the ignition voltage such that 50% of the fuel/air mixture is combusted at a crankshaft angle between 6° and 10° after the top dead center point, with which the power stroke starts.

By monitoring pressure of the combustion chamber and/or temperature the ignition of the fuel/air mixture can be detected and the combustion process observed.

The energy input necessary to achieve ignition and a 50% combustion at the intended crankshaft angles can be determined by characteristic curves or characteristic maps. Moreover, the energy input can be increased in a follwing cycle if ignition of the fuel/air mixture occurs too late of lowered if it occurs to soon. Thus a closed loop control can be used to adapt the energy input and thereby ignition can be achieved at the intended crankshaft angle.

In controlling the corona discharge, it is increased to a first maximum and then decreased before injection of fuel. After injection of fuel, the corona discharge is increased to a second maximum. The size of a corona ignition can be increased by increasing the voltage applied to the electrode from which the corona discharge originates.

While exemplary embodiments incorporating the principles of the present invention have been disclosed hereinabove, the present invention is not limited to the disclosed embodiments. Instead, this application is intended to cover any variations, uses, or adaptations of the invention using its general principles. Further, this application is intended to cover such departures from the present disclosure as come within known or customary practice in the art to which this invention pertains and which fall within the limits of the appended claims.

1-15. (canceled)

16. A method for controlling the ignition point of a fuel/air mixture in a cyclically operating internal combustion engine by means of at least one corona discharge originating from an electrode, the method comprising:
starting the corona discharge or at least one of a plurality of corona discharges at a crankshaft angle between 400° and 200° before the top dead center, with which a power stroke of the engine starts, by applying an ignition voltage to the electrode or the electrodes; and
controlling the energy input of the corona discharge or of the corona discharges by adapting the burn time of the corona discharge and the strength of the ignition voltage such that the fuel/air mixture ignites at a crankshaft angle between 30° and 5° before the top dead center, with which the power stroke starts, and 50% of the fuel/air mixture is combusted at a crankshaft angle between 6° and 10° after the top dead center point, with which the power stroke starts.

17. The method according to claim 16, wherein the corona discharge or at least one of the corona discharges is started before the injection of fuel.

18. The method according to claim 16, wherein the power released by the corona discharge or the plurality of corona discharges during a work cycle of the internal combustion engine has at least two maxima.

19. The method according to claim 16, wherein the power released by the corona discharge or the plurality of corona discharges during a work cycle of the internal combustion engine has at least two maxima.

20. The method according to claim 18, wherein the first maximum is reached before the injection of fuel and the second maximum is reached after the injection of fuel.

21. The method according to claim 18, wherein the second maximum is smaller than the first maximum.

22. The method according to claim 16, wherein while the engine is running, the corona discharge or at least one of the corona discharges is always ignited at least at a crankshaft angle of 120° before the injection of fuel.

23. The method according to claim 16, wherein while the engine is running, the corona discharge or at least one of the corona discharges is always ignited at least at a crankshaft angle of 150° before the injection of fuel.

24. The method according to claim 16, wherein the energy input of the corona discharge or corona discharges is controlled such that the fuel mixture when the engine is running is always ignited at a crankshaft angle between 30° and 5° before the top dead center, with which the power stroke starts.

25. The method according to claim 16, wherein the energy input of the corona discharge or corona discharges is controlled such that the fuel mixture is always ignited at a crankshaft angle between 25° and 5° before the top dead center, with which the power stroke starts.

26. The method according to claim 16, wherein the energy input of the corona discharge or corona discharges is controlled such that the fuel mixture is always ignited at a crankshaft angle between 20° and 5° before the top dead center, with which the power stroke starts.

27. The method according to claim 16, wherein the crankshaft angle always changes by at least 150° whilst the corona discharge or at least one of the corona discharges burns when the engine is running.

28. The method according to claim 16, wherein the crankshaft angle always changes by at least 180° whilst the corona discharge or at least one of the corona discharges burns when the engine is running.

29. The method according to claim 16, wherein the corona discharge or one of the plurality of corona discharges is generated in an intake passage of the engine.

30. The method according to claim 16, wherein the corona discharge or at least one of the plurality of corona discharges is generated in a combustion chamber of the engine.

31. The method according to claim 16, wherein at least one of the corona discharges is generated in the intake passage and at least one of the corona discharges is generated in the combustion chamber of the engine.

32. The method according to claim 31, wherein the corona discharge in the intake passage and the corona discharge in the combustion chamber are started sequentially.

33. The method according to claim 16, wherein a homogeneous compression ignition is prepared by the at least one corona discharge.

34. The method according to claim 16, wherein a target value for the ignition point is predefined according to the operating state of the engine and the start and duration of the at least one corona discharge are then determined according to this target value.
